(19) United States
(12) Patent Application Publication
(10) Pub. No.: US 2026/0153815 A1
(43) Pub. Date: Jun. 4, 2026

(54) DEVELOPING DEVICE AND IMAGE FORMING APPARATUS

(71) Applicant: FUJIFILM Business Innovation Corp., Tokyo (JP)

(72) Inventors: Mizue SEKINE, Kanagawa (JP); Mitsutoshi HONGO, Kanagawa (JP); Atsushi FUNADA, Kanagawa (JP)

(73) Assignee: FUJIFILM Business Innovation Corp., Tokyo (JP)

(21) Appl. No.: 19/211,272

(22) Filed: May 18, 2025

(30) Foreign Application Priority Data
Nov. 29, 2024 (JP) 2024-208976
Nov. 29, 2024 (JP) 2024-208977

(51) Int. Cl. G03G 15/09; G03G 21/20

(52) U.S. Cl. CPC G03G 15/0921; G03G 15/0942; G03G 21/206

(57) ABSTRACT

A developing device includes a rotating member that is formed in a tubular shape, that is provided to be rotatable, that includes one end portion and the other end portion, and that includes an outer peripheral surface to which a developer adheres, plural magnetic poles that are disposed inside the rotating member and that are disposed to be arranged in a rotation direction of the rotating member, a first magnetic member that is disposed outside the rotating member, that is disposed at a position facing the one end portion of the rotating member, that includes a downstream-side end portion, which is an end portion positioned on a downstream side in the rotation direction of the rotating member, and that forms a magnetic field between the first magnetic member and the magnetic poles, and a second magnetic member that is disposed outside the rotating member, that is disposed at a position facing the one end portion of the rotating member, that is disposed to be closer to the other end portion of the rotating member than the first magnetic member is, that forms a magnetic field between the second magnetic member and the magnetic poles, and that includes a facing portion, which is a portion facing the rotating member, in which, in the rotation direction, the facing portion of the second magnetic member is positioned upstream of one of the plural magnetic poles that is positioned upstream of the downstream-side end portion of the first magnetic member in the rotation direction and that is a first magnetic pole counting from the downstream-side end portion.

### CROSS-REFERENCE TO RELATED APPLICATIONS

This application is based on and claims priority under 35 USC 119 from Japanese Patent Application No. 2024-208976 filed Nov. 29, 2024 and Japanese Patent Application No. 2024-208977 filed Nov. 29, 2024.

### BACKGROUND

### (i) Technical Field

The present invention relates to a developing device and an image forming apparatus.

(ii) Related Art

Disclosed in JP2015-222403A is a developing device having a configuration in which an outer peripheral surface of a developer carrier includes, regarding an axial direction of the developer carrier, a first region including a development region and second regions that are adjacent to the first region at positions outward of the first region and that have a developer transportability lower than the developer transportability of the first region or substantially no transportability, and boundaries between the first region and the second regions of the outer peripheral surface of the developer carrier are positioned between magnetic seal members and magnetic members in the axial direction of the developer carrier, the boundaries being at both end portions in the axial direction of the developer carrier.

In addition, disclosed in JP2023-79747A is a developing device including a development sleeve that carries a developer and that rotates, a scattered toner collecting member that is disposed on a downstream side in a rotation direction of the development sleeve along a gap between an image carrier and the development sleeve, a collection duct that is connected to the scattered toner collecting member, a suction fan that is connected to the collection duct and that sucks toner collected by the scattered toner collecting member, and a blowing screw that is provided in the collection duct, that sucks the toner collected by the scattered toner collecting member, and that blows the toner toward the suction fan.

### SUMMARY

Regarding a developing device used for development, magnetic poles are disposed inside a tubular rotating member in some cases so that a developer adheres to an outer peripheral surface of the rotating member.

Here, in the case of a configuration in which a magnetic member is disposed outside the rotating member, the developer on the outer peripheral surface of the rotating member may be moved by the magnetic member. In such a case, the way in which the developer adheres to the outer peripheral surface of the rotating member may be different from the way in which the developer is originally supposed to adhere to the outer peripheral surface of the rotating member.

Aspects of non-limiting embodiments of the present disclosure relate to the developing device that is to lower, in comparison with a configuration in which a magnetic member is disposed at a position facing a magnetic pole positioned inside a tubular rotating member, a probability that the way in which a developer adheres to an outer peripheral surface of the rotating member is made different from the way in which the developer is originally supposed to adhere to the outer peripheral surface of the rotating member.

In addition, in an image forming apparatus, development may be performed by using a developing device, so that an image is formed. Here, in a case where there is a position in the developing device to which air is not easily supplied, a developer is likely to stay at the position and deposition of the developer is likely to occur. In a case where the deposition of the developer occurs, a problem such as a development failure is likely to occur.

Aspects of non-limiting embodiments of the present disclosure relate to the image forming apparatus that is to lower the probability of deposition of a developer in a developing device in comparison with a configuration in which there is a position to which air is not easily supplied.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a developing device including a rotating member that is formed in a tubular shape, that is provided to be rotatable, that includes one end portion and the other end portion, and that includes an outer peripheral surface to which a developer adheres, a plurality of magnetic poles that are disposed inside the rotating member and that are disposed to be arranged in a rotation direction of the rotating member, a first magnetic member that is disposed outside the rotating member, that is disposed at a position facing the one end portion of the rotating member, that includes a downstream-side end portion, which is an end portion positioned on a downstream side in the rotation direction of the rotating member, and that forms a magnetic field between the first magnetic member and the magnetic poles, and a second magnetic member that is disposed outside the rotating member, that is disposed at a position facing the one end portion of the rotating member, that is disposed to be closer to the other end portion of the rotating member than the first magnetic member is, that forms a magnetic field between the second magnetic member and the magnetic poles, and that includes a facing portion, which is a portion facing the rotating member, in which, in the rotation direction, the facing portion of the second magnetic member is positioned upstream of one of the plurality of magnetic poles that is positioned upstream of the downstream-side end portion of the first magnetic member in the rotation direction and that is a first magnetic pole counting from the downstream-side end portion.

### BRIEF DESCRIPTION OF THE DRAWINGS

Exemplary embodiment(s) of the present invention will be described in detail based on the following figures, wherein:

FIG. 1 is a view illustrating an image forming apparatus;

FIG. 2 is a view of a developing device as seen from above;

FIG. 3 is a cross-sectional view of the developing device taken along line III-III in FIG. 2;

FIG. 4 is a cross-sectional view of the developing device taken along line IV-IV in FIG. 2;

FIG. 5 is a cross-sectional view of the developing device taken along line V-V in FIG. 2;

FIG. 6 is an explanatory view for description of a developer suction mechanism in the developing device;

FIG. 7 is a view showing how one end portion of the developing device is in a case where the one end portion is seen in a direction represented by an arrow VII in FIG. 2;

FIG. 8 is a perspective view showing one end portion side of the developing device as seen from the other end portion side of the developing device;

FIG. 9 is a perspective view showing the one end portion of the developing device as seen in a direction represented by an arrow IX in FIG. 7;

FIG. 10 is a view of the developing device as seen from below;

FIG. 11 is a perspective view of a cross section of the developing device taken along line XI-XI OF FIG. 7;

FIGS. 12A and 12B are views for comparison between the sizes of a first opening and a second opening, where FIG. 12A is a view showing the first opening and FIG. 12B is a view showing the second opening;

FIG. 13 is an explanatory view for description of a developer scattering prevention mechanism in the developing device;

FIG. 14 is a view showing a first magnetic member, a second magnetic member, and the like as seen in a direction represented by an arrow XIV in FIG. 13;

FIG. 15 is a view showing one end portion of a facing member as seen from obliquely above and as seen from the other end portion side;

FIG. 16 is a cross-sectional view of the developing device taken along the line XVI-XVI of FIG. 15; and

FIGS. 17A and 17B are views showing a comparative example regarding the second magnetic member or the like.

### DETAILED DESCRIPTION

An exemplary embodiment of the present invention will be described below with reference to the accompanying drawings.

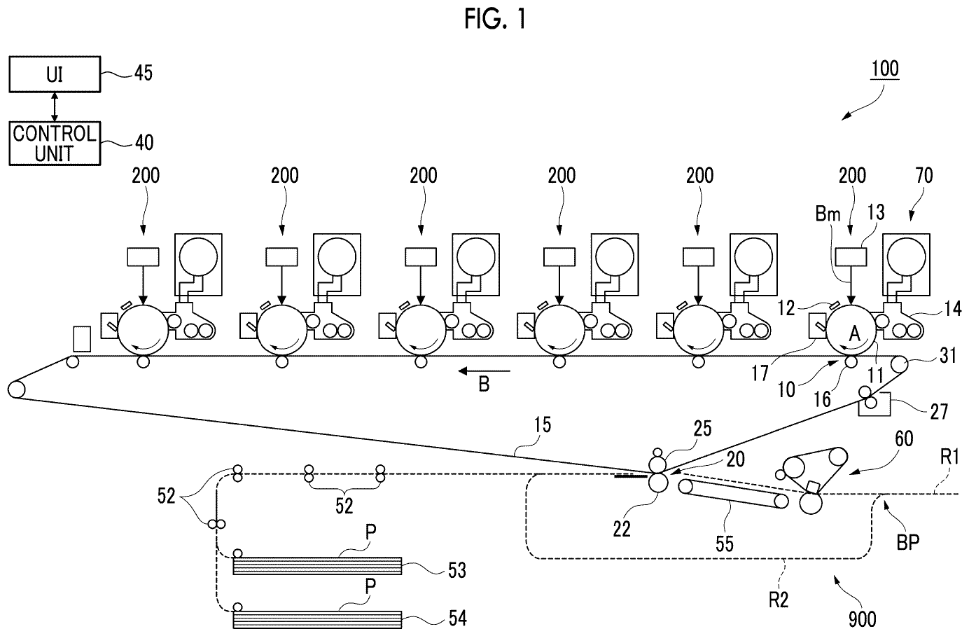

FIG. 1 is a view showing an image forming apparatus 100 according to the present exemplary embodiment. FIG. 1 shows a state related to a case where the image forming apparatus 100 is seen from a side ahead of the image forming apparatus 100.

The image forming apparatus 100 is an intermediate transfer type image forming apparatus 100, which is called a tandem type image forming apparatus.

The image forming apparatus 100 is provided with a plurality of image forming units 200 that form images to be transferred to a paper sheet P, which is an example of a recording medium.

Each of the image forming units 200 includes a photoreceptor drum 11, which is an example of an image holding body, and forms a toner image, which is an image to be transferred to the paper sheet P, on the photoreceptor drum 11 by using a developer containing toner. In other words, each of the image forming units 200 forms, on the photoreceptor drum 11 by using a powdery developer, a toner image to be transferred to the paper sheet P.

A developer of the present exemplary embodiment is composed of a dry carrier and dry toner. Each of the image forming units 200 uses a carrier and toner to form a toner image on the photoreceptor drum 11.

Six image forming units 200 form toner images on the photoreceptor drums 11 by using different types of developers.

Specifically, in the present exemplary embodiment, four of the six image forming units 200 form toner images by using developers of basic colors which are yellow, magenta, cyan, and black.

In addition, the remaining two image forming units 200 form toner images by using a developer of a color other than the basic colors, such as clear, white, gold, silver, pink, green, or orange.

Note that examples of the developer of a color other than the basic colors include a developer containing magnetic toner and a developer containing conductive toner, in addition to the above-described developer. In addition, examples of the developer of a color other than the basic colors include a developer containing toner that emits light in a case where the toner is irradiated with light such as ultraviolet rays or infrared rays.

In the present exemplary embodiment, a so-called two-component developer in which a carrier and toner are mixed with each other is used as the developer. However, the present invention is not limited thereto, and a so-called one-component developer composed of toner only may also be used as the developer.

In addition, the image forming apparatus 100 is provided with an intermediate transfer belt 15 and primary transfer units 10 provided to transfer toner images to the intermediate transfer belt 15, the toner images being respectively formed by the image forming units 200.

Furthermore, the image forming apparatus 100 is provided with a secondary transfer unit 20 provided to transfer, to the paper sheet P, the toner images transferred onto the intermediate transfer belt 15.

In addition, the image forming apparatus 100 is provided with a fixing device 60 that fixes, onto the paper sheet P, the toner images transferred onto the paper sheet P.

Furthermore, the image forming apparatus 100 is provided with a control unit 40 that includes a CPU executing a program and that controls each unit in the image forming apparatus 100.

In addition, the image forming apparatus 100 is provided with a user interface (UI) 45 that is composed of a display panel or the like, that receives an instruction from a user, and that displays information with respect to the user.

Each of the image forming units 200 is provided with a developing device 14. In addition, each of the image forming units 200 is provided with a developer replenishment device 70 that replenishes the developing device 14 with a developer.

The developing device 14 visualizes an electrostatic latent image on the photoreceptor drum 11 with toner. In other words, the developing device 14 performs photographic development with respect to the photoreceptor drum 11, which is an image holding body, to form, on the photoreceptor drum 11, an image formed by the toner.

The developer replenishment device 70 replenishes the developing device 14 with a developer. As described above, a developer is composed of a carrier and toner, and the developer replenishment device 70 replenishes the developing device 14 with a carrier and toner as a developer. Note that in the present exemplary embodiment, a carrier has a positive charging polarity, and toner has a negative charging polarity.

In each of the image forming units 200, the photoreceptor drum 11 which is an example of an image holding body rotates in a direction along an arrow A.

In addition, each of the image forming units 200 is provided with a charger 12 that charges the photoreceptor drum 11 and a laser exposure device 13 which is an example of an exposure device forming an electrostatic latent image on the photoreceptor drum 11. In FIG. 1, an exposure beam from the laser exposure device 13 is represented by a reference numeral “Bm”. Note that the exposure device may be composed of a device including a light source, such as an LED.

In addition, each of the image forming units 200 is provided with a primary transfer roll 16 that transfers a toner image formed on the photoreceptor drum 11 to the intermediate transfer belt 15 at the primary transfer unit 10. In addition, each of the image forming units 200 is provided with a drum cleaner 17 that removes a developer remaining on the photoreceptor drum 11.

A drive roll 31 driven by a motor (not shown) causes the intermediate transfer belt 15 to circulate and move at a predetermined speed in a direction along an arrow B which is shown in FIG. 1.

The primary transfer unit 10 is configured to include the primary transfer roll 16 that is disposed to face the photoreceptor drum 11 with the intermediate transfer belt 15 interposed therebetween. In addition, respective toner images on the photoreceptor drums 11 are electrostatically attracted onto the intermediate transfer belt 15 in order, so that superimposed toner images are formed on the intermediate transfer belt 15.

The secondary transfer unit 20 which is an example of a transfer unit is configured to include a secondary transfer roll 22 that is disposed on an outer surface side of the intermediate transfer belt 15 and a backup roll 25 that is disposed on an inner surface side of the intermediate transfer belt 15.

In the present exemplary embodiment, at the secondary transfer unit 20, toner images that are formed by the image forming units 200 and that are transferred to the intermediate transfer belt 15 are transferred to the paper sheet P transported to the secondary transfer unit 20.

Furthermore, in the present exemplary embodiment, an inversion mechanism 900 that inverts the paper sheet P is provided.

The inversion mechanism 900 inverts the paper sheet P with one surface on which the toner images have been transferred at the secondary transfer unit 20 upside down and supplies the paper sheet P again to the secondary transfer unit 20.

Accordingly, in the present exemplary embodiment, toner images can be formed on both surfaces of the paper sheet P.

Specifically, in the present exemplary embodiment, the inversion mechanism 900 inverts the paper sheet P upside down by feeding the paper sheet P, which has passed through the fixing device 60, to a branch path R2 branching off a paper sheet transport path R1. Specifically, after the paper sheet P passes through a branching portion BP, the inversion mechanism 900 transports the paper sheet P in a reverse direction and feeds the paper sheet P to the branch path R2.

The branch path R2 joins the paper sheet transport path R1 at a position upstream of the secondary transfer unit 20. Accordingly, in the present exemplary embodiment, the paper sheet P inverted upside down is supplied again to the secondary transfer unit 20. In this case, toner images are formed not only on the one surface of the paper sheet P but also on the other surface of the paper sheet P, so that the toner images are formed on both surfaces of the paper sheet P.

The flow of processing performed in the image forming apparatus 100 will be described.

The image forming apparatus 100 receives image data output from, for example, an image reading apparatus (not shown) or a computer. Then, the image data is subjected to image processing. Accordingly, image data corresponding to each of the plurality of image forming units 200 is generated.

Specifically, for example, image data used for image formation in which the developers of the basic colors, which are yellow, magenta, cyan, and black, are used and image data used for image formation in which the developer of a color other than the basic colors is used are generated. The generated image data is output to the laser exposure devices 13 provided at the image forming units 200.

In accordance with the image data input to the laser exposure devices 13, the laser exposure devices 13 irradiate the photoreceptor drums 11 with the exposure beams Bm emitted from, for example, semiconductor lasers.

In the present exemplary embodiment, after respective surfaces of the photoreceptor drums 11 are charged by the chargers 12, the surfaces are scanned and exposed to light by the laser exposure devices 13. Accordingly, electrostatic latent images are formed on the surfaces of the photoreceptor drums 11.

Next, development processing is performed by the developing devices 14 so that toner images are formed on the photoreceptor drums 11. The toner images are transferred onto the intermediate transfer belt 15 at the primary transfer units 10.

After the toner images are transferred onto the intermediate transfer belt 15, the toner images are moved to the secondary transfer unit 20 as the intermediate transfer belt 15 moves. In addition, at this time, the paper sheet P from a first paper sheet accommodation portion 53 or a second paper sheet accommodation portion 54 is transported to the secondary transfer unit 20 by transport rolls 52 or the like.

Then, the toner images on the intermediate transfer belt 15 are electrostatically transferred onto the paper sheet P in a collective manner at the secondary transfer unit 20.

Thereafter, the paper sheet P onto which the toner images have been transferred is peeled from the intermediate transfer belt 15 and is transported to a transport belt 55. The transport belt 55 transports the paper sheet P to the fixing device 60.

The paper sheet P transported to the fixing device 60 is heated and pressed by the fixing device 60. Accordingly, the toner images on the paper sheet P are fixed to the paper sheet P. Then, the paper sheet P is discharged from the image forming apparatus 100.

Note that in a case where toner images are to be formed on both surfaces of the paper sheet P, the paper sheet P is supplied again to the secondary transfer unit 20 through the branch path R2 after the paper sheet P passes through the fixing device 60.

Then, toner images are transferred to the other surface of the paper sheet P at the secondary transfer unit 20. Thereafter, the paper sheet P passes through the fixing device 60 again and the toner images transferred to the other surface are fixed to the paper sheet P.

The developing devices 14 will be described.

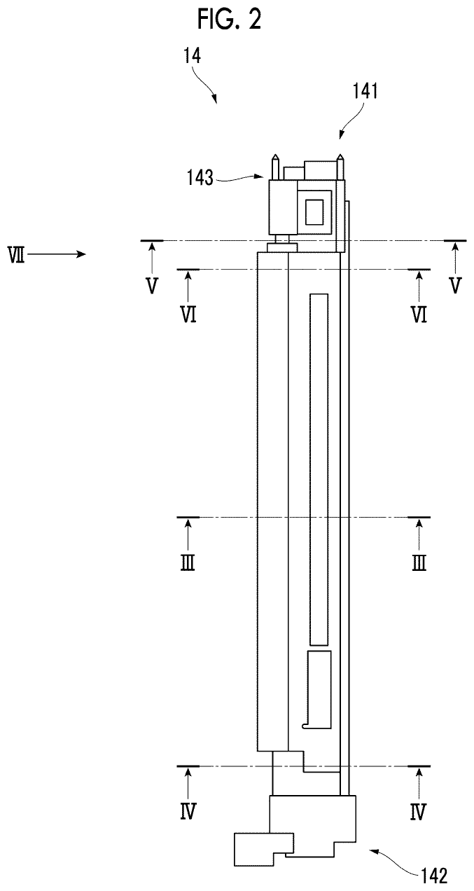

FIG. 2 is a view showing the developing device 14 as seen from above.

In a case where the developing device 14 is installed in the image forming apparatus 100, the developing device 14 is disposed along a depth direction of the image forming apparatus 100. The developing device 14 includes one end portion 141 and the other end portion 142, of which the positions are different from each other in a longitudinal direction.

In a case where the developing device 14 is installed in the image forming apparatus 100, the developing device 14 is installed in the image forming apparatus 100 such that the one end portion 141 is positioned on a rear side of the image forming apparatus 100 and the other end portion 142 is positioned on a front side of the image forming apparatus 100.

A drive force receiving portion 143 that receives a drive force is provided at the one end portion 141 of the developing device 14.

In the present exemplary embodiment, a drive force from a drive source (not shown), such as a motor, is transmitted to the drive force receiving portion 143, the drive source being provided on a body side of the image forming apparatus 100.

The drive force receiving portion 143 is linked to a transport member or the like (which will be described later) provided inside the developing device 14. In the present exemplary embodiment, the transport member or the like is rotated as the drive force from the drive source is transmitted to the drive force receiving portion 143.

In the present exemplary embodiment, as will be described later, four members, which are a one-direction transport member, an opposite-direction transport member, a facing member, and a lower-side transport member, are provided as members that rotate as the drive force is received from the drive source. The drive force receiving portion 143 may be provided to correspond to each of the four members. In addition, a drive force from the drive source may be transmitted to each of four drive force receiving portions 143.

In addition, alternatively, drive force receiving portions 143 of which the number is smaller than the number of the four members, for example, one drive force receiving portion 143, may be provided. In addition, a drive force transmitted from the drive source to the drive force receiving portion 143 may be transmitted to each of the four members through a transmission mechanism (not shown) provided at the developing device 14.

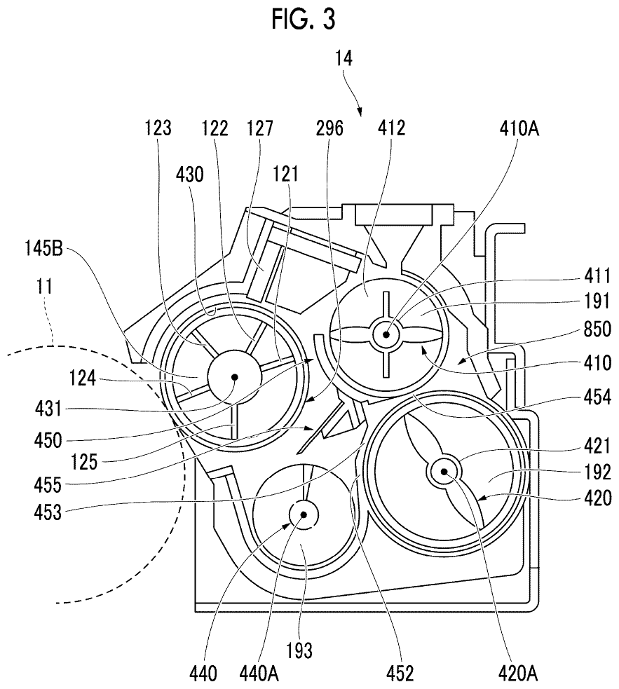

FIG. 3 is a cross-sectional view of the developing device 14 taken along line III-III in FIG. 2. FIG. 3 shows the state of a cross section of a central portion of the developing device 14 in the longitudinal direction.

The developing device 14 is provided with a one-direction movement path 191 through which a developer passes in a case where the developer is to be moved in one direction.

In addition, the developing device 14 is provided with an opposite-direction movement path 192 through which the developer passes in a case where the developer is to be moved in a direction opposite to the one direction. The opposite-direction movement path 192 is disposed below the one-direction movement path 191.

In the one-direction movement path 191, the developer moves in a direction perpendicular to the paper surface of FIG. 3 and in a direction to the rear side of the paper surface. In addition, in the opposite-direction movement path 192, the developer moves in a direction perpendicular to the paper surface of FIG. 3 and in a direction to the front side of the paper surface.

The one-direction movement path 191 is provided with a one-direction transport member 410 that transports the developer. In the present exemplary embodiment, the developer moves in the direction to the rear side as the one-direction transport member 410 rotates around a rotary shaft 411 that extends along the one-direction movement path 191.

More specifically, in the present exemplary embodiment, the developer moves in the direction to the rear side as the one-direction transport member 410 receives a drive force transmitted from the above-described drive force receiving portion 143 (refer to FIG. 2) and the one-direction transport member 410 rotates.

In the present exemplary embodiment, the one-direction transport member 410 transports the developer in the direction to the rear side, which is the one direction. The one-direction transport member 410 is a rotating member that rotates around an axis 410A extending along the one direction.

The opposite-direction movement path 192 is provided with an opposite-direction transport member 420 that transports the developer. The opposite-direction transport member 420 is disposed below the one-direction transport member 410.

In the present exemplary embodiment, the developer moves in the direction to the front side as the opposite-direction transport member 420 rotates around a rotary shaft 421 that extends along the opposite-direction movement path 192.

More specifically, the developer moves in the direction to the front side as the opposite-direction transport member 420 receives a drive force transmitted from the above-described drive force receiving portion 143 and the opposite-direction transport member 420 rotates.

In the present exemplary embodiment, the opposite-direction transport member 420 transports the developer in the direction opposite to the one direction.

A facing member 430 that is disposed at a position facing the photoreceptor drum 11, which is an example of an image holding body, is provided to the left of the one-direction transport member 410.

The facing member 430 supplies, to the photoreceptor drum 11, a developer supplied from the one-direction transport member 410. The developer is supplied from the one-direction transport member 410 to the facing member 430 and the facing member 430 supplies the developer to the photoreceptor drum 11.

The facing member 430 is composed of a cylindrical body. The facing member 430 is formed of, for example, a metal such as SUS.

The facing member 430 receives a drive force transmitted from the drive force receiving portion 143, rotates in a counterclockwise direction in the drawing around an axis 431, and moves, to the photoreceptor drum 11, a developer that is supplied from the one-direction transport member 410 and that adheres to an outer peripheral surface of the facing member 430.

Accordingly, the developer is supplied to the photoreceptor drum 11, and toner contained in the developer adheres to a surface of the photoreceptor drum 11.

The facing member 430 is a rotating member that rotates around the axis 431 extending along the above-described one direction. In addition, the one-direction transport member 410 is also a rotating member that rotates around the axis 410A extending along the above-described one direction.

In the present exemplary embodiment, the facing member 430 and the one-direction transport member 410 are provided such that the axis 410A of the one-direction transport member 410 is positioned above the axis 431 of the facing member 430.

Furthermore, in the present exemplary embodiment, a first movement restriction portion 450 that is disposed between the facing member 430 and the one-direction transport member 410 and that restricts movement of a portion of a developer caused to move toward the facing member 430 from the one-direction transport member 410 is provided.

In the present exemplary embodiment, a part of a developer on the one-direction movement path 191 that moves over the first movement restriction portion 450 is supplied to the facing member 430.

Furthermore, in the present exemplary embodiment, a lower-side transport member 440 that is disposed below the facing member 430 is provided. The lower-side transport member 440 is a rotating member that rotates around an axis 440A extending along the above-described one direction.

The lower-side transport member 440 is disposed closer to the photoreceptor drum 11 side than the opposite-direction transport member 420 is.

The lower-side transport member 440 and the opposite-direction transport member 420 are disposed along the above-described one direction and are disposed in a state where the positions thereof are offset from each other in a horizontal direction.

The lower-side transport member 440 transports a developer separated from the facing member 430 in the direction perpendicular to the paper surface of FIG. 3 and in the direction to the rear side of the paper surface.

The lower-side transport member 440 transports the developer separated from the facing member 430 in the above-described one direction, so that the developer is supplied to one end portion side of the opposite-direction transport member 420 (details will be described later).

The lower-side transport member 440 is rotated by a drive force transmitted from the drive force receiving portion 143, so that the lower-side transport member 440 transports a developer separated from the facing member 430 in the direction perpendicular to the paper surface of FIG. 3 and in the direction to the rear side of the paper surface.

The lower-side transport member 440 is provided on a lower-side movement path 193 that is disposed closer to the photoreceptor drum 11 side than the opposite-direction movement path 192 is.

The lower-side movement path 193 is disposed to extend in the direction perpendicular to the paper surface of FIG. 3 and is disposed below the facing member 430. In the present exemplary embodiment, the developer separated from the facing member 430 moves along the lower-side movement path 193.

Furthermore, in the present exemplary embodiment, a second movement restriction portion 452 that is disposed between the lower-side transport member 440 and the opposite-direction transport member 420 and that restricts movement of a developer moving toward the lower-side transport member 440 from the opposite-direction transport member 420 is provided.

In addition, in the present exemplary embodiment, a third movement restriction portion 453 that is disposed between the facing member 430 and the opposite-direction transport member 420 and that restricts movement of a developer moving toward the facing member 430 from the opposite-direction transport member 420 is provided.

Furthermore, in the present exemplary embodiment, a fourth movement restriction portion 454 is provided between the one-direction transport member 410 and the opposite-direction transport member 420.

The fourth movement restriction portion 454 restricts movement of a developer moving from the one-direction transport member 410 to the opposite-direction transport member 420. In addition, the fourth movement restriction portion 454 restricts movement of a developer moving from the opposite-direction transport member 420 to the one-direction transport member 410.

In the present exemplary embodiment, the second to fourth movement restriction portions 452 to 454 are integrated with each other. The second to fourth movement restriction portions 452 to 454 are configured by means of one common component.

Furthermore, in the present exemplary embodiment, a fifth movement restriction portion 455 that is disposed between the facing member 430 and the lower-side transport member 440 and that restricts movement of a developer moving toward the facing member 430 from the lower-side transport member 440 is provided.

Furthermore, in the present exemplary embodiment, a magnet roll 145B is provided inside the facing member 430.

The magnet roll 145B is provided with five magnetic poles 121 to 125 arranged in a circumferential direction of the magnet roll 145B.

The magnetic pole 121 is a pickup pole and attracts a developer supplied from the one-direction movement path 191. Accordingly, the developer adheres to a surface of the facing member 430.

The magnetic poles 122 to 124 have a role as transport poles and move the developer on the surface of the facing member 430 to a downstream side in a rotation direction of the facing member 430.

In the rotation direction of the facing member 430, a facing restriction portion 127 is provided downstream of the magnetic pole 122 and upstream of the magnetic pole 123. In addition, the facing restriction portion 127 is disposed at a position facing the outer peripheral surface of the facing member 430.

The facing restriction portion 127 is disposed with a gap provided between the facing restriction portion 127 and the facing member 430.

The facing restriction portion 127 restricts movement of a portion of a developer adhering to the surface of the facing member 430, so that the thickness of the developer adhering to the surface of the facing member 430 becomes a predetermined thickness.

In other words, the facing restriction portion 127 restricts movement of a portion of a developer that adheres to the outer peripheral surface of the facing member 430 and that moves toward the photoreceptor drum 11 as the facing member 430 rotates.

In a case where the developer on the surface of the facing member 430 moves to the downstream side in the rotation direction of the facing member 430, the developer moves to the surface of the photoreceptor drum 11 which is an example of an image holding body and toner contained in the developer adheres to the photoreceptor drum 11.

Accordingly, development is performed, and an image consisting of the toner is formed on the surface of the photoreceptor drum 11.

The image is temporarily held by the photoreceptor drum 11 and is moved to the primary transfer unit 10 (refer to FIG. 1) with the photoreceptor drum 11 rotating. Then, the image is transferred to the intermediate transfer belt 15.

The magnetic pole 125 has a role as a pick-off pole, forms a repulsive magnetic field, and causes the developer adhering to the surface of the facing member 430 to be separated from the facing member 430. The magnetic pole 125 causes the developer that remains on the surface of the facing member 430 without being transferred to the photoreceptor drum 11 to be separated from the facing member 430.

In the present exemplary embodiment, separation of the developer occurs at a separation position 296.

In the present exemplary embodiment, the separation position 296 is positioned ahead of the magnetic pole 121 having a role as a pickup pole, and the developer is separated ahead of the magnetic pole 121 in the present exemplary embodiment.

The developer separated from the facing member 430 moves downward and reaches the lower-side movement path 193.

The developer that has reached the lower-side movement path 193 is moved toward the one end portion 141 (refer to FIG. 2) side of the developing device 14 by the lower-side transport member 440, and then is moved to the opposite-direction movement path 192 (refer to FIG. 3) (details will be described later).

The one-direction transport member 410 (see FIG. 3), the opposite-direction transport member 420, the facing member 430, the magnet roll 145B, and the lower-side transport member 440 are disposed to extend in the direction perpendicular to the paper surface of FIG. 3 and to be parallel to each other.

The one-direction transport member 410 includes the rotary shaft 411 that extends along the longitudinal direction of the developing device 14 and a protruding portion 412 that protrudes from an outer peripheral surface of the rotary shaft 411.

The protruding portion 412 is provided over an area extending from one end portion to the other end portion of the rotary shaft 411 in an axial direction and is provided in a spiral shape. In other words, the protruding portion 412 is provided in a screw-like shape.

In the present exemplary embodiment, in a case where the rotary shaft 411 provided at the one-direction transport member 410 rotates, the protruding portion 412 presses a developer in the axial direction of the rotary shaft 411 and thus the developer moves in a direction in which the rotary shaft 411 extends.

Note that the opposite-direction transport member 420 and the lower-side transport member 440 have the same configuration as the one-direction transport member 410, and the opposite-direction transport member 420 and the lower-side transport member 440 are also provided with a rotary shaft extending along the longitudinal direction of the developing device 14 and a protruding portion having a spiral shape.

The one-direction transport member 410, the opposite-direction transport member 420, the facing member 430, and the lower-side transport member 440 are rotating members that rotate around axes extending along the above-described one direction.

In the present exemplary embodiment, an axis 420A of the opposite-direction transport member 420 is positioned to be farther from the facing member 430 than the axis 410A of the one-direction transport member 410 is in a case where the positions of the axes in the horizontal direction are compared with each other.

In addition, in the present exemplary embodiment, the axis 420A of the opposite-direction transport member 420 is positioned at a position offset from a position directly below the axis 410A of the one-direction transport member 410.

In addition, in the present exemplary embodiment, the axis 440A of the lower-side transport member 440 is positioned at a position offset from a position directly below the axis 431 of the facing member 430.

More specifically, in the present exemplary embodiment, the axis 440A of the lower-side transport member 440 is positioned to be closer to the opposite-direction transport member 420 than the axis 431 of the facing member 430 is in a case where the positions of the axes in the horizontal direction are compared with each other.

Furthermore, in the present exemplary embodiment, the axis 440A of the lower-side transport member 440 is positioned below the axis 420A of the opposite-direction transport member 420 in a case where the positions of the axes in a perpendicular direction are compared with each other.

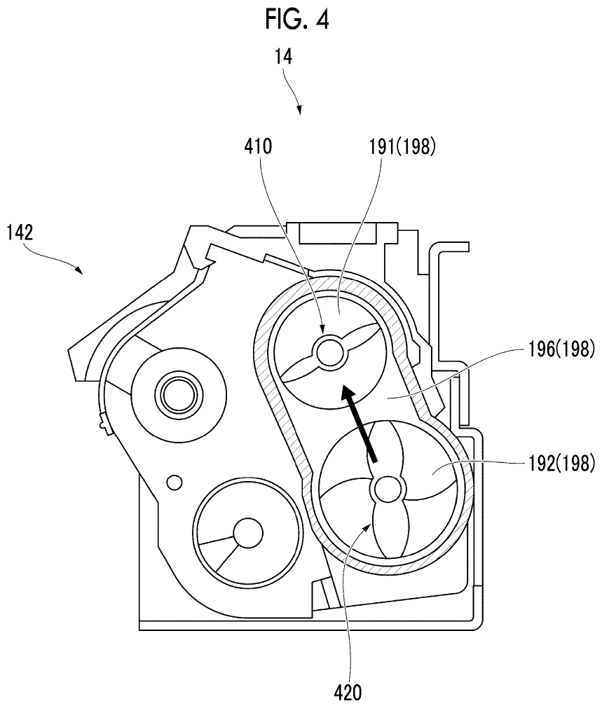

FIG. 4 is a cross-sectional view of the developing device 14 taken along line IV-IV in FIG. 2.

FIG. 4 shows the state of a cross section of the other end portion 142 of the developing device 14.

In the present exemplary embodiment, as shown in FIG. 4, an upward movement path 196 disposed along the vertical direction is provided at the other end portion 142 of the developing device 14.

In the present exemplary embodiment, a developer that has moved through the opposite-direction movement path 192 moves toward the one-direction movement path 191 through the upward movement path 196.

In the developing device 14 of the present exemplary embodiment, the upward movement path 196 which is an example of a second movement path, through which a developer moving from the opposite-direction transport member 420 to the one-direction transport member 410 passes, is provided.

Here, the expression “being disposed along the vertical direction” means not only a state where the upward movement path 196 is disposed along the perpendicular direction but also a state where the upward movement path 196 is disposed in a state of being inclined with respect to the perpendicular direction.

In the present exemplary embodiment, in a case where a developer is transported to the other end portion 142 of the developing device 14 by the opposite-direction transport member 420, the developer accumulates at a lower portion of the upward movement path 196 and the developer gradually moves upward in the upward movement path 196.

Accordingly, the developer is supplied to the one-direction transport member 410. The one-direction transport member 410 transports, toward the one end portion 141 (refer to FIG. 2) of the developing device 14 along the one-direction movement path 191, a developer that has moved through the upward movement path 196.

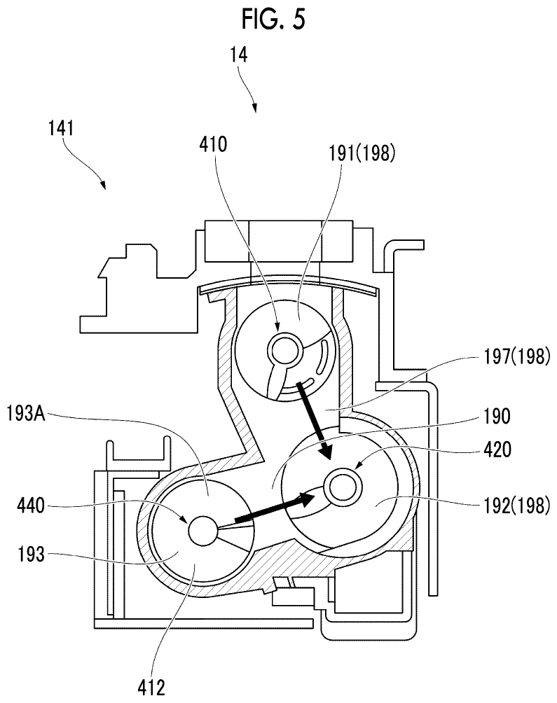

FIG. 5 is a cross-sectional view of the developing device 14 taken along line V-V in FIG. 2.

In the present exemplary embodiment, as shown in FIG. 5, a downward movement path 197 disposed along the vertical direction is provided at the one end portion 141 of the developing device 14.

Here, the expression “being disposed along the vertical direction” means not only a state where the downward movement path 197 is disposed along the perpendicular direction but also a state where the downward movement path 197 is disposed in a state of being inclined with respect to the perpendicular direction.

In the present exemplary embodiment, a developer that has moved through the one-direction movement path 191 moves toward the opposite-direction movement path 192 through the downward movement path 197.

In the present exemplary embodiment, the downward movement path 197 which is an example of a first movement path, through which a developer moving from the one-direction transport member 410 to the opposite-direction transport member 420 passes, is provided.

In the present exemplary embodiment, a developer that has moved through the one-direction movement path 191 moves toward the opposite-direction movement path 192 through the downward movement path 197. Next, the developer moves toward the other end portion 142 (refer to FIG. 2) of the developing device 14 through the opposite-direction movement path 192.

In the developing device 14 of the present exemplary embodiment, a developer movement path 198 that is formed in an annular shape by four paths, which are the one-direction movement path 191, the downward movement path 197, the opposite-direction movement path 192, and the upward movement path 196 (refer to FIG. 4), is provided.

In the present exemplary embodiment, a developer circulates and moves along the annular developer movement path 198.

Furthermore, in the present exemplary embodiment, as shown in FIG. 5, a connection path 190 that extends in a lateral direction and that connects the lower-side movement path 193 and the opposite-direction movement path 192 to each other is provided.

In the present exemplary embodiment, the connection path 190 which is an example of a movement path for a developer moving from the lower-side transport member 440 to the opposite-direction transport member 420 is provided.

The connection path 190 is disposed in a state of being inclined to extend obliquely upward. In other words, the connection path 190 is disposed in a state of being inclined with respect to both the horizontal direction and the perpendicular direction.

In the present exemplary embodiment, a developer that has been moved along the lower-side movement path 193 by the lower-side transport member 440 moves to the opposite-direction movement path 192 through the connection path 190.

In the present exemplary embodiment, a developer accumulating at an end portion of the lower-side movement path 193 that is positioned on a downstream side in a developer movement direction moves to the opposite-direction movement path 192 through the connection path 190 by being pressed by a developer sequentially transported from an upstream side.

In the developing device 14 of the present exemplary embodiment, as described above, the annular developer movement path 198 is provided, and a developer is agitated as the developer moves through the annular developer movement path 198.

Furthermore, in the present exemplary embodiment, while a developer to be agitated is passing through the one-direction movement path 191 (refer to FIG. 3), the developer is partially supplied to the facing member 430 over the first movement restriction portion 450 and the developer adheres to the surface of the facing member 430.

As the facing member 430 rotates, the developer adhering to the surface of the facing member 430 is moved to a position facing the photoreceptor drum 11 and thus the developer is supplied to the photoreceptor drum 11.

In a case where a portion of the developer that adheres to the surface of the facing member 430 and that is not supplied to the photoreceptor drum 11 passes through a position facing the magnetic pole 125 (refer to FIG. 3) having a role as a pick-off pole and in a case where the developer reaches the separation position 296, the developer is separated from the facing member 430 and moves downward.

The developer moving downward reaches the lower-side movement path 193 provided with the lower-side transport member 440.

The developer that has reached the lower-side movement path 193 moves through the lower-side movement path 193 to reach an end portion 193A of the lower-side movement path 193 that is positioned on the downstream side in the developer movement direction.

Thereafter, the developer moves to the opposite-direction movement path 192 through the connection path 190 by being pressed by a developer sequentially transported from the upstream side.

In a case where the developer moves to the opposite-direction movement path 192, the developer moves along the annular developer movement path 198 again.

The developing device 14 will be further described.

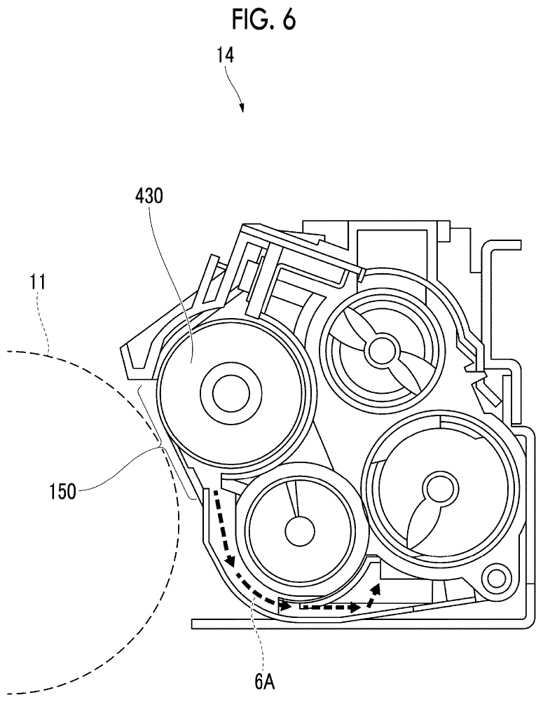

FIG. 6 is an explanatory view for description of a developer suction mechanism in the developing device 14. FIG. 6 shows a cross section of the developing device 14 taken along line VI-VI of FIG. 2.

In the present exemplary embodiment, as shown in FIG. 6, the developing device 14 is provided with an opening portion 150 facing the photoreceptor drum 11.

In the present exemplary embodiment, the facing member 430 is partially exposed through the opening portion 150.

In the present exemplary embodiment, the opening portion 150 is positioned between the photoreceptor drum 11 and a central portion of the facing member 430 in a radial direction.

The facing member 430 supplies a developer to the photoreceptor drum 11. The facing member 430 can also be regarded as a supply member.

The opening portion 150 is provided to extend in the longitudinal direction of the developing device 14. The opening portion 150 is provided to extend along an axial direction of the facing member 430.

In the image forming apparatus 100 of the present exemplary embodiment, a suction unit that sucks air is provided on a body side of the image forming apparatus 100.

In the present exemplary embodiment, suction performed by the suction unit causes air to flow in the developing device 14 as represented by arrows 6A in FIG. 6. Accordingly, a developer floating around the developing device 14 is moved to the suction unit.

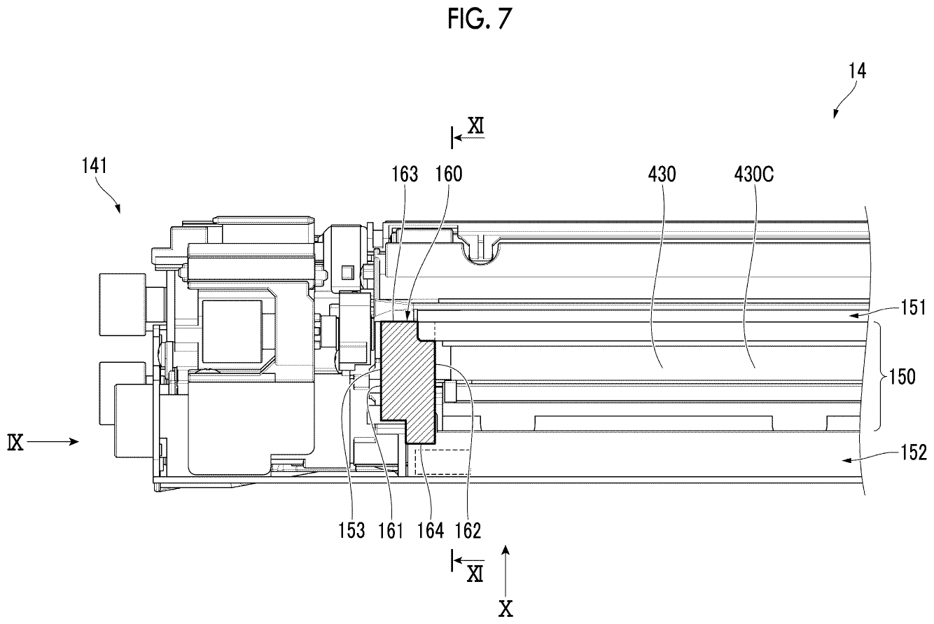

FIG. 7 is a view showing how the one end portion 141 of the developing device 14 is in a case where the one end portion 141 is seen in a direction represented by an arrow VII in FIG. 2. FIG. 7 shows the developing device 14 as seen from the opening portion 150 side.

The opening portion 150 of the developing device 14 is provided with an opening upper portion 151 that forms an upper edge of the opening portion 150 and an opening lower portion 152 that forms a lower edge of the opening portion 150.

In addition, the opening portion 150 is provided with an opening left portion 153 that forms a left edge of the opening portion 150 and an opening right portion that forms a right edge of the opening portion 150. The opening right portion is not shown.

A portion of the outer peripheral surface of the facing member 430, which is exposed through the opening portion 150, is positioned between the opening upper portion 151 and the opening lower portion 152.

Furthermore, in the present exemplary embodiment, a blocking member 160 that partially blocks the opening portion 150 is provided. The blocking member 160 restricts movement of a developer.

In the present exemplary embodiment, a developer moves toward the photoreceptor drum 11 side shown in FIG. 1 from the facing member 430 side.

The blocking member 160 restricts movement of the developer moving toward the photoreceptor drum 11 side from the facing member 430 side. The blocking member 160 can also be regarded as a restriction member that restricts movement of a developer.

In the case of the developing device 14, air is taken into the developing device 14 in a case where a developer adhering to the outer peripheral surface of the facing member 430 returns to the developing device 14. Accordingly, the internal pressure of the developing device 14 increases.

Due to the increase in internal pressure, the developer in the developing device 14 is caused to move to the outside of the developing device 14 through the opening portion 150. In this case, the developer moves toward the photoreceptor drum 11 side from the facing member 430 side.

The blocking member 160 restricts movement of the developer moving toward the photoreceptor drum 11 side from the facing member 430 side.

The blocking member 160 is provided in a plate-like shape. The plate-shaped blocking member 160 is provided along the axial direction of the facing member 430. In addition, the plate-shaped blocking member 160 is provided along a circumferential direction of the facing member 430.

The blocking member 160 is formed of, for example, a resin material. Examples of the resin material include polyethylene terephthalate and polyurethane.

The blocking member 160 includes a left end portion 161 which is an example of one axial end portion and a right end portion 162 which is the other axial end portion, the right and left end portions 161 and 162 being at different positions in the axial direction of the facing member 430.

The right end portion 162 is positioned closer to a central portion 430C side of the facing member 430 in the axial direction than the left end portion 161 is.

The right end portion 162 can be understood as an end portion on a central side, which is an end portion positioned on the central portion 430C side of the facing member 430 in the axial direction.

The left end portion 161 is positioned on a side opposite to the right end portion 162 which is the central-portion-side end portion.

The left end portion 161 can be regarded as an opposite-side end portion positioned on a side opposite to the right end portion 162.

In addition, the blocking member 160 includes an upper end portion 163 that is positioned on an upstream side in the rotation direction of the facing member 430. In addition, the blocking member 160 includes a lower end portion 164 that is positioned on the downstream side in the rotation direction of the facing member 430.

The blocking member 160 is disposed at a position facing an end portion of the facing member 430 in the axial direction.

The upper end portion 163 of the blocking member 160 is affixed to, for example, a bearing member provided at an end portion of the facing member 430. The bearing member is a member that supports the facing member 430 in a rotatable state.

The upper end portion 163 of the blocking member 160 may be affixed to a member other than the bearing member, such as a housing.

In addition, the lower end portion 164 of the blocking member 160 is affixed to the opening lower portion 152.

The lower end portion 164 is affixed to a surface of the opening lower portion 152, that is, a surface on the photoreceptor drum 11 side. Note that the lower end portion 164 may be affixed to a rear surface of the opening lower portion 152, that is, a surface on the facing member 430 side.

The blocking member 160 is provided to cover a left side of the opening portion 150 in the drawing.

Although the description will not be provided, the blocking member 160 is also provided on a right side of the opening portion 150. The blocking member 160 is also provided at a position facing the other end portion 433 of the facing member 430.

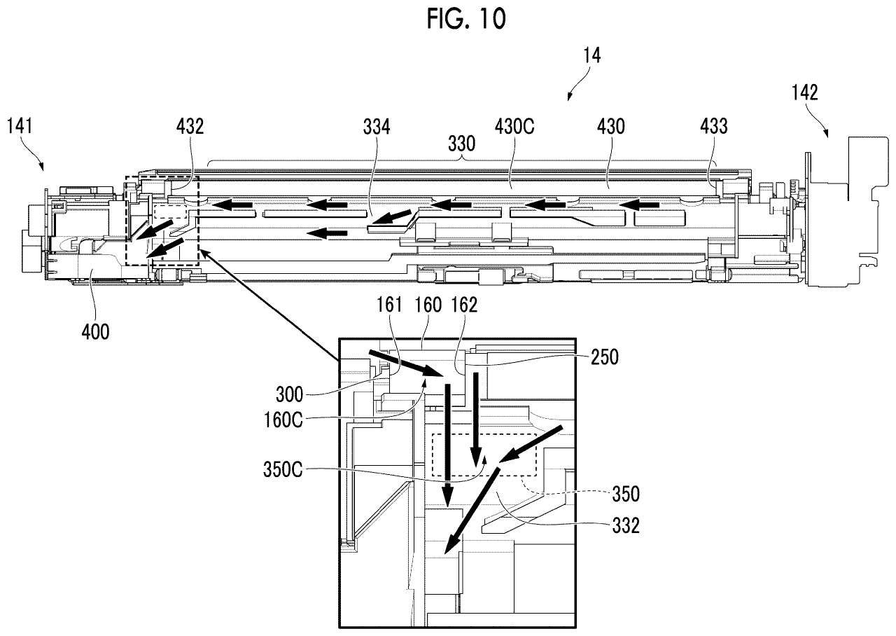

Note that the other end portion 433 of the facing member 430 is shown in FIG. 10.

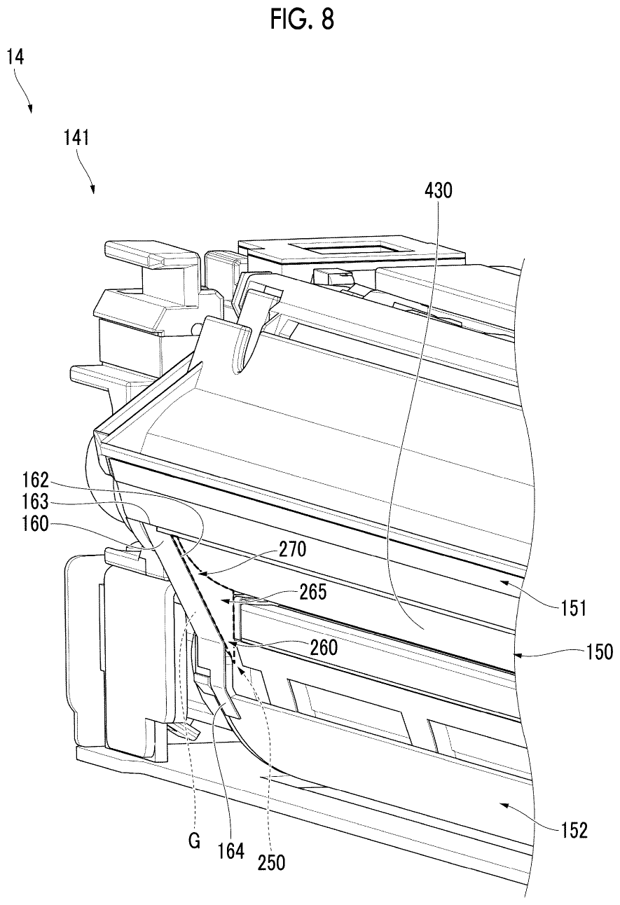

FIG. 8 is a perspective view showing the one end portion 141 side of the developing device 14 as seen from the other end portion 142 side of the developing device 14.

The blocking member 160 is disposed between the photoreceptor drum 11 shown in FIG. 6 and the facing member 430 disposed at a position facing the photoreceptor drum 11.

In the present exemplary embodiment, as described above, the upper end portion 163 of the blocking member 160 is affixed to the bearing member provided at the end portion of the facing member 430. In addition, the lower end portion 164 is affixed to the opening lower portion 152.

In the present exemplary embodiment, the blocking member 160 is disposed in a state where a gap G is provided between the blocking member 160 and a plurality of constituent members constituting the developing device 14.

The blocking member 160 is disposed in a state where the gap G is provided between the blocking member 160 and the facing member 430 which is an example of a constituent member.

In the present exemplary embodiment, the blocking member 160 and the facing member 430 are not in contact with each other. The gap G is provided between the blocking member 160 and the facing member 430.

A first opening 250 through which air outside the gap G can flow into the gap G is provided between the right end portion 162 of the blocking member 160 and the facing member 430.

The first opening 250 is provided to extend in the vertical direction. The first opening 250 has different widths in the vertical direction.

Specifically, the width of a portion 260 positioned below a central portion 265 of the first opening 250 in the vertical direction and the width of a portion 270 positioned above the central portion 265 are smaller than the width of the central portion 265 of the first opening 250.

The first opening 250 is formed such that the width of the first opening 250 increases from the portion 260 positioned below the central portion 265 toward the central portion 265. In addition, the first opening 250 is formed such that the width of the first opening 250 increases from the portion 270 positioned above the central portion 265 toward the central portion 265.

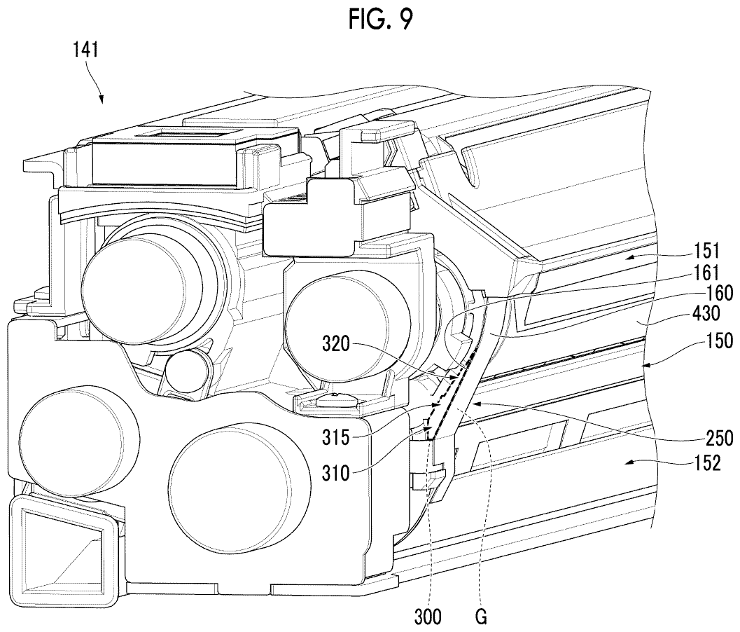

FIG. 9 is a perspective view showing the one end portion 141 of the developing device 14 as seen in a direction represented by an arrow IX in FIG. 7.

In the present exemplary embodiment, a second opening 300 is provided between the left end portion 161 of the blocking member 160 and the facing member 430. In the present exemplary embodiment, air outside the gap G flows into the gap G through the second opening 300.

In the present exemplary embodiment, as shown in FIG. 9, the second opening 300 is provided to extend in the vertical direction.

In addition, the second opening 300 is formed to have different widths in the vertical direction.

Specifically, the width of a portion 310 positioned below a central portion 315 of the second opening 300 in the vertical direction and the width of a portion 320 positioned above the central portion 315 are different from each other.

The width of the portion 310 of the second opening 300 that is positioned on a lower side in the vertical direction is larger than the width of the portion 320 that is positioned on an upper side.

Regarding the second opening 300, the width of the second opening 300 increases from the portion 320 positioned on the upper side toward the portion 310 positioned on the lower side.

FIG. 10 is a view of the developing device 14 as seen from below. FIG. 10 shows how the developing device 14 is in a case where the developing device 14 is seen in a direction represented by an arrow X in FIG. 7.

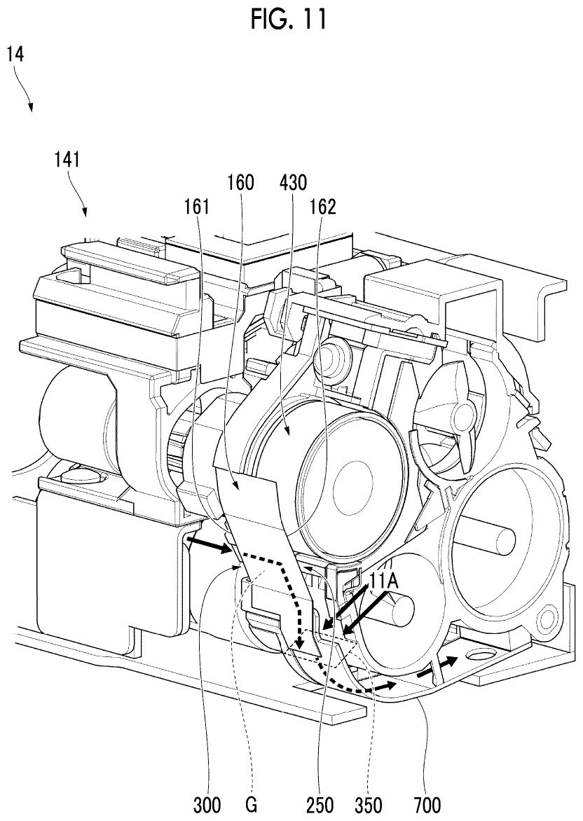

In addition, FIG. 11 is a perspective view of a cross section of the developing device 14 taken along line XI-XI of FIG. 7.

Note that in FIG. 10, a state where an exterior cover 700 provided at a lower portion of the developing device 14 is removed is shown in order to show how air flows in the developing device 14. In the present exemplary embodiment, as shown in FIG. 11, the exterior cover 700 is provided. FIG. 10 shows a state where the exterior cover 700 is removed.

In the present exemplary embodiment, as shown in FIG. 10, a discharge portion 400 through which air in the developing device 14 is discharged is provided on the one end portion 141 side of the developing device 14. The discharge portion 400 is a so-called duct and is composed of an annular member.

In the present exemplary embodiment, air in the developing device 14 moves, through the discharge portion 400, toward the suction unit (not shown) provided on the body side of the image forming apparatus 100.

As shown in FIG. 11, an inlet portion 350 that air moving toward the discharge portion 400 enters is provided on the one end portion 141 side of the developing device 14.

Furthermore, as shown in FIG. 10, a flow path 330 provided along the axial direction of the facing member 430 is provided.

A developer floating at a position facing the central portion 430C or the like of the facing member 430 moves toward the inlet portion 350 through the flow path 330.

Here, positions in the rotation direction of the facing member 430 will be compared with each other with reference to FIG. 11.

In the present exemplary embodiment, the position of the inlet portion 350 in the rotation direction is different from the positions of the first opening 250 and the second opening 300 in the rotation direction.

The inlet portion 350 is provided downstream of the first opening 250 and the second opening 300 in the rotation direction of the facing member 430.

In addition, positions in the axial direction of the facing member 430 will be compared with each other with reference to FIG. 10.

In the present exemplary embodiment, the position of the inlet portion 350 in the axial direction and the position of the second opening 300 in the axial direction are different from each other.

The inlet portion 350 is positioned closer to the central portion 430C side of the facing member 430 in the axial direction than a central portion 160C of the blocking member 160 is.

The inlet portion 350 includes a central portion 350C positioned at an intermediate position in a width direction.

The central portion 350C of the inlet portion 350 is positioned closer to the central portion 430C side of the facing member 430 in the axial direction than the central portion 160C of the blocking member 160 is.

The inlet portion 350 is provided in a state of being close to the central portion 430C side of the facing member 430 in the axial direction with respect to the blocking member 160.

Furthermore, the developing device 14 is provided with a connection flow path 332 that connects the discharge portion 400 and the inlet portion 350 to each other. The connection flow path 332 is provided to extend in the rotation direction of the facing member 430. In addition, the connection flow path 332 is provided to extend in the axial direction of the facing member 430.

The connection flow path 332 is provided to be inclined with respect to both the rotation direction and the axial direction of the facing member 430.

Air that has passed through the inlet portion 350 moves toward the discharge portion 400 through the connection flow path 332.

In a case where the connection flow path 332 is provided to be inclined, a stream of air flowing in an oblique downward direction as represented by arrows 11A in the drawing is likely to be generated outside the inlet portion 350 shown in FIG. 11.

In this case, air caused to move toward the inlet portion 350 is likely to pass through the installation position of the first opening 250, but is unlikely to pass through the second opening 300.

In a case where the second opening 300 is not provided and the second opening 300 is blocked in such a case, a developer is likely to accumulate at the installation position of the second opening 300. In this case, a developer is likely to be solidified at the installation position of the second opening 300.

In this case, the solidified developer falls to the inlet portion 350 or the connection flow path 332 positioned downstream of the inlet portion 350. Accordingly, an air flow path is narrowed. In a case where the air flow path is narrowed, it is difficult for air to be discharged from the developing device 14. In this case, a failure such as a development failure is likely to occur.

On the other hand, in the configuration of the present exemplary embodiment, a stream of air flowing toward the inlet portion 350 from the second opening 300 is generated. Accordingly, a developer is less likely to accumulate at the installation position of the second opening 300. In this case, the above-described failure is less likely to occur.

In the present exemplary embodiment, as described above, air in the developing device 14 moves toward the discharge portion 400.

In this case, a portion of the air enters the gap G through the first opening 250 shown in FIG. 11. Then, the air moves toward the inlet portion 350.

Furthermore, air enters the gap G through the second opening 300. Then, the air also moves toward the inlet portion 350.

As described above, in the present exemplary embodiment, air is supplied to the gap G formed between the blocking member 160 and the facing member 430 in a plurality of directions. In the present exemplary embodiment, air can be supplied to the inside of the gap G from the outside of the gap G in a plurality of directions.

In the present exemplary embodiment, air is supplied to the gap G from the right end portion 162 side of the blocking member 160. In addition, in the present exemplary embodiment, air is supplied to the gap G from the left end portion 161 side of the blocking member 160.

In the present exemplary embodiment, air can be supplied to the gap G from both the first opening 250 side and the second opening 300 side.

Note that in the present exemplary embodiment, as shown in FIG. 10, a flow path 334 through which air moving toward the discharge portion 400 passes is provided separately from the flow path 330 and the connection flow path 332. A portion of air moving toward the discharge portion 400 from a right side in the axial direction of the facing member 430 moves toward the discharge portion 400 through the flow path 334.

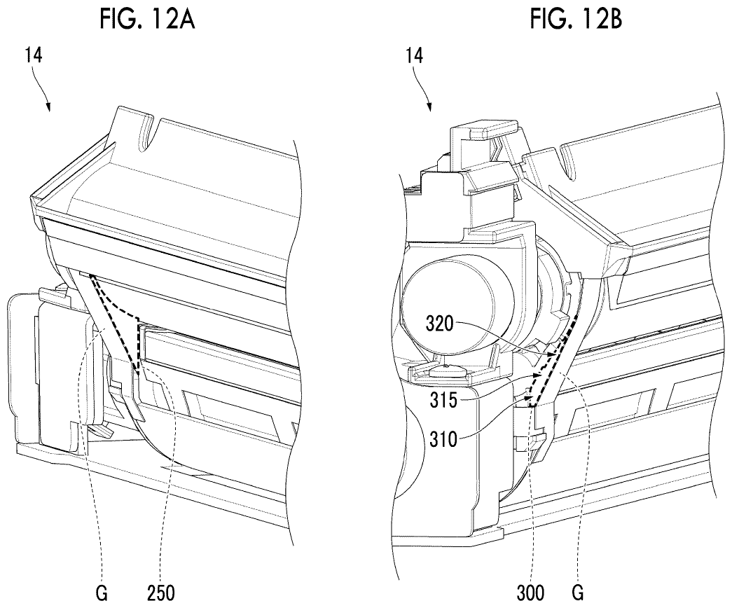

FIGS. 12A and 12B are views for comparison between the size of the first opening 250 and the size of the second opening 300. FIG. 12A is a view showing the first opening 250, and FIG. 12B is a view showing the second opening 300.

In the present exemplary embodiment, the sizes of the first opening 250 and the second opening 300 are different from each other.

In the present exemplary embodiment, the area of the second opening 300 is smaller than the area of the first opening 250.

Accordingly, a developer in the gap G is restrained from moving to the outside of the gap G through the second opening 300.

In the present exemplary embodiment, as represented by the arrows 11A in FIG. 11, generally, air enters the gap G from the first opening 250 side.

In this case, a portion of the air entering the gap G from the first opening 250 side may move to the outside of the gap G through the second opening 300. In this case, a developer in the gap G is likely to move to the outside of the gap G through the second opening 300.

However, in the present exemplary embodiment, as described above, the area of the second opening 300 is smaller than the area of the first opening 250. In this case, a developer in the gap G is less likely to move to the outside of the gap G through the second opening 300 in comparison with a case where the area of the second opening 300 is larger than the area of the first opening 250.

Furthermore, in the present exemplary embodiment, as described above and shown in FIG. 12B, the width of the portion 310 of the second opening 300 that is positioned on the lower side is larger than the width of the portion 320 of the second opening 300 that is positioned on the upper side.

In this case, the amount of air supplied to the lower side, on which the developer is likely to accumulate, is increased and thus accumulation of the developer is suppressed.

In the second opening 300, a developer is likely to accumulate at the portion 310 of the second opening 300 that is positioned on the lower side. In the present exemplary embodiment, air favorably flows at a position where such accumulation is likely to occur and a developer is less likely to accumulate at the position where such accumulation is likely to occur.

Next, developer scattering prevention mechanisms in the developing device 14 will be described.

Hereinafter, a scattering prevention mechanism positioned on one end portion 432 side in the axial direction of the facing member 430 will be described. The same scattering prevention mechanism is also provided on the other end portion 433 side in the axial direction of the facing member 430.

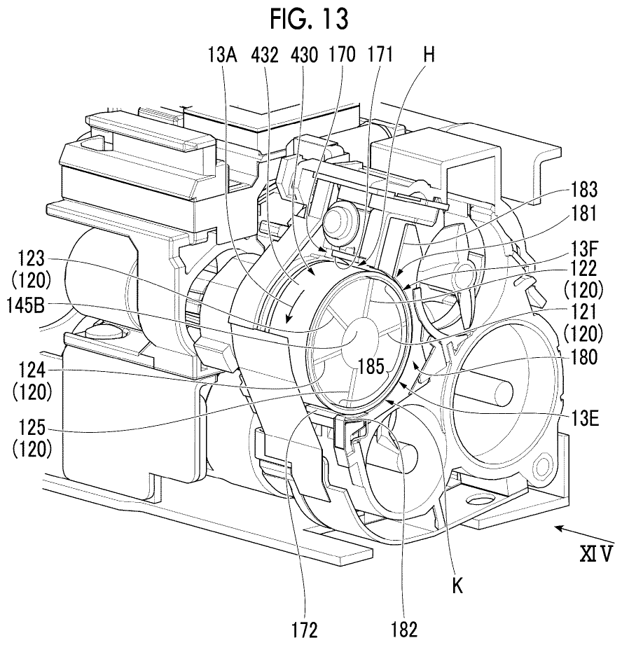

FIG. 13 is an explanatory view for description of a developer scattering prevention mechanism in the developing device 14. FIG. 13 is the same view as FIG. 11.

In the present exemplary embodiment, as described above, the magnet roll 145B is provided inside the facing member 430. The magnet roll 145B is provided with a plurality of magnetic poles.

In the present exemplary embodiment, the five magnetic poles 121 to 125 are provided as the plurality of magnetic poles. The five magnetic poles 121 to 125 are disposed to be arranged along the circumferential direction of the magnet roll 145B. The five magnetic poles 121 to 125 are provided to be arranged in the rotation direction of the facing member 430.

Hereinafter, in the present specification, each of the five magnetic poles 121 to 125 will be referred to as a “magnetic pole 120” in a case where the five magnetic poles 121 to 125 are not to be particularly distinguished from each other.

In addition, hereinafter, in the present specification, the five magnetic poles 121 to 125 will be referred to as a “first to fifth magnetic poles 121 to 125” in a case where the five magnetic poles 121 to 125 are to be particularly distinguished from each other.

A first magnetic member 170 that forms a magnetic field between the first magnetic member 170 and a plurality of the magnetic poles 120 is provided outside the facing member 430.

The first magnetic member 170 is provided at a position facing the one end portion 432 of the facing member 430 in the axial direction. The first magnetic member 170 is provided outside the facing member 430.

The first magnetic member 170 is composed of a plate-shaped member having a curvature.

In addition, the first magnetic member 170 is provided in a state where a gap H is provided between the first magnetic member 170 and the facing member 430. In addition, the first magnetic member 170 is provided along the outer peripheral surface of the facing member 430.

In addition, the first magnetic member 170 includes a downstream-side end portion 171 that is an end portion positioned on the downstream side in the rotation direction of the facing member 430.

In addition, the first magnetic member 170 includes an upstream-side end portion 172 that is an end portion positioned on the upstream side in the rotation direction of the facing member 430.

In the drawing, the rotation direction of the facing member 430 is represented by an arrow 13A.

Furthermore, in the present exemplary embodiment, a second magnetic member 180 that forms a magnetic field between the second magnetic member 180 and the plurality of magnetic poles 120 is provided outside the facing member 430.

The second magnetic member 180 is also provided at a position facing the one end portion 432 of the facing member 430 in the axial direction.

The second magnetic member 180 is also provided in a state where a gap K is provided between the second magnetic member 180 and the facing member 430.

The second magnetic member 180 is provided closer to the other end portion 433 side of the facing member 430 than the first magnetic member 170 is. The other end portion 433 of the facing member 430 is shown in FIG. 10.

In addition, the second magnetic member 180 is provided closer to the central portion 430C side of the facing member 430 in the axial direction than the first magnetic member 170 is. The central portion 430C is also shown in FIG. 10.

The second magnetic member 180 is formed in a plate-like shape. The plate-shaped second magnetic member 180 is provided along the radial direction of the facing member 430.

The second magnetic member 180 includes a facing portion 185 that is a portion facing the facing member 430. The facing portion 185 is provided along the outer peripheral surface of the facing member 430.

The facing portion 185 is disposed at a facing position of the plurality of magnetic poles 120 provided inside the facing member 430. Specifically, the facing portion 185 is disposed at a position facing the first magnetic pole 121 and the fifth magnetic pole 125.

The facing portion 185 includes a downstream-side end portion 181 that is an end portion positioned on the downstream side in the rotation direction of the facing member 430. In addition, the facing portion 185 includes an upstream-side end portion 182 that is an end portion positioned on the upstream side in the rotation direction of the facing member 430.

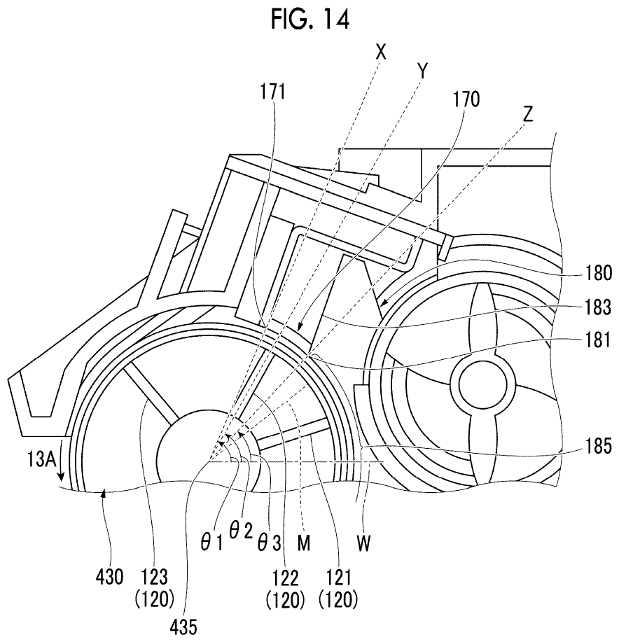

FIG. 14 is a view showing the first magnetic member 170, the second magnetic member 180, and the like as seen in a direction represented by an arrow XIV in FIG. 13.

Here, a positional relationship in the rotation direction of the facing member 430 will be described. In FIG. 14, the rotation direction of the facing member 430 is represented by an arrow 13A.

In FIG. 14, the downstream-side end portion 171 of the first magnetic member 170, the second magnetic pole 122, the downstream-side end portion 181 of the facing portion 185, and the first magnetic pole 121 are shown.

The downstream-side end portion 171 of the first magnetic member 170, the second magnetic pole 122, the downstream-side end portion 181 of the facing portion 185, and the first magnetic pole 121 are provided in the order of the downstream-side end portion 171 of the first magnetic member 170, the second magnetic pole 122, the downstream-side end portion 181 of the facing portion 185, and the first magnetic pole 121 from the downstream side to the upstream side in the rotation direction of the facing member 430.

The second magnetic pole 122 is positioned upstream of the downstream-side end portion 171 of the first magnetic member 170 in the rotation direction of the facing member 430. The second magnetic pole 122 is one of the plurality of magnetic poles 120 that is the first magnetic pole counting from the downstream-side end portion 171 to the upstream side.

In addition, the first magnetic pole 121 is also positioned upstream of the downstream-side end portion 171 of the first magnetic member 170 in the rotation direction of the facing member 430. The first magnetic pole 121 is the second magnetic pole counting from the downstream-side end portion 171 to the upstream side.

The downstream-side end portion 181 of the facing portion 185 is positioned upstream of the second magnetic pole 122 in the rotation direction of the facing member 430.

In addition, the downstream-side end portion 181 of the facing portion 185 is positioned downstream of the first magnetic pole 121 in the rotation direction of the facing member 430.

The downstream-side end portion 181 of the facing portion 185 is positioned upstream of the second magnetic pole 122 in the rotation direction of the facing member 430 and is positioned on downstream of the first magnetic pole 121 in the rotation direction of the facing member 430.

In other words, the downstream-side end portion 181 of the second magnetic member 180 is positioned between the second magnetic pole 122 and the first magnetic pole 121 in the rotation direction of the facing member 430.

Here, it will be assumed that an intermediate position M is between the second magnetic pole 122 and the first magnetic pole 121. The intermediate position M is a position between the second magnetic pole 122 and the first magnetic pole 121 in the rotation direction of the facing member 430. A distance between the intermediate position M and the second magnetic pole 122 is equal to a distance between the intermediate position M and the first magnetic pole 121. Each “distance” herein refers to a distance measured along the circumferential direction of the facing member 430.

In the present exemplary embodiment, the downstream-side end portion 181 of the facing portion 185 is positioned downstream of the intermediate position M in the rotation direction of the facing member 430.

The downstream-side end portion 181 of the facing portion 185 is provided in a state of being closer to the second magnetic pole 122 side than the first magnetic pole 121 is in the rotation direction of the facing member 430.

Here, it will be assumed that a virtual plane Y extends along the radial direction of the facing member 430 and extends toward the second magnetic pole 122 from a rotation center 435 of the facing member 430.

In the present exemplary embodiment, a downstream-side edge 183 of the second magnetic member 180 is provided upstream of the virtual plane Y in the rotation direction of the facing member 430.

Although not described above, the second magnetic member 180 includes the downstream-side edge 183.

The downstream-side edge 183 is one of a plurality of edges of the second magnetic member 180 that is positioned closest to the downstream side in the rotation direction of the facing member 430.

The downstream-side edge 183 is connected to the facing portion 185 at the downstream-side end portion 181 of the facing portion 185.

The downstream-side edge 183 extends in a direction away from the facing member 430 in a case where a connection position between the downstream-side edge 183 and the facing portion 185 is a starting point. Furthermore, the downstream-side edge 183 is formed in a linear shape.

The downstream-side edge 183 is inclined to the downstream side in the rotation direction of the facing member 430.

Here, it will be assumed that a virtual plane Z extends through the rotation center 435 of the facing member 430 and the downstream-side end portion 181 and extends along the radial direction of the facing member 430.

In the present exemplary embodiment, the downstream-side edge 183 is inclined with respect to the virtual plane Z. The downstream-side edge 183 of the second magnetic member 180 is provided to be inclined to be closer to the downstream side in the rotation direction of the facing member 430 than the virtual plane Z is.

In the present exemplary embodiment, the downstream-side edge 183 is provided upstream of the virtual plane Y in the rotation direction of the facing member 430, as described above.

Furthermore, in the present exemplary embodiment, the entire downstream-side edge 183 is provided upstream of the virtual plane Y in the rotation direction of the facing member 430.

Furthermore, it will be assumed that a virtual plane X extends toward the downstream-side end portion 171 of the first magnetic member 170 from the rotation center 435 of the facing member 430. In addition, it will be assumed that the virtual plane Z extends toward the downstream-side end portion 181 of the second magnetic member 180 from the rotation center 435 of the facing member 430 as described above.

In addition, here, it will be assumed that a reference plane W extends through the rotation center 435 of the facing member 430 and extends in a horizontal direction.

Furthermore, it will be assumed that an angle θ1 is formed between the plane X and the reference plane W, an angle θ2 is formed between the plane Y and the reference plane W, and an angle θ3 is formed between the plane Z and the reference plane W.

In the present exemplary embodiment, the downstream-side end portion 171 of the first magnetic member 170 is provided such that the angle θ1 is larger than the angle θ2.

In addition, the downstream-side end portion 181 of the second magnetic member 180 is provided such that the angle θ2 is larger than the angle θ3.

In the present exemplary embodiment, the angle θ1 is approximately 70°. In addition, the angle θ2 is approximately 61°. Furthermore, the angle θ3 is approximately 48°.

In this case, a value obtained by subtracting the angle θ2 from the angle θ1 is smaller than a value obtained by subtracting the angle θ3 from the angle θ2.

In the case of a configuration in which such a relationship between the angles is established, the virtual plane Y is provided in a state of being close to the virtual plane X.

In this case, the second magnetic pole 122 is disposed in a state of being closer to the downstream-side end portion 171 side of the first magnetic member 170 than the downstream-side end portion 181 of the facing portion 185 is.

Note that the angles described above are examples, and the values of the angles are not limited to such values.

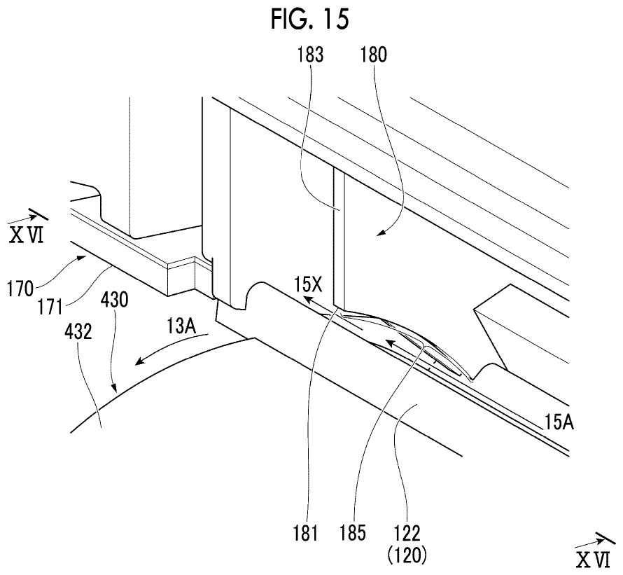

FIG. 15 is a view showing the one end portion 432 of the facing member 430 as seen from obliquely above and as seen from the other end portion 433 side.

In FIG. 15, the second magnetic pole 122 is also shown outside the facing member 430 for the sake of easy understanding of a positional relationship between members. In practice, the second magnetic pole 122 is provided inside the facing member 430.

In the present exemplary embodiment, as described above, the second magnetic pole 122 is positioned upstream of the downstream-side end portion 171 of the first magnetic member 170 in the rotation direction of the facing member 430.

In addition, the second magnetic pole 122 is positioned downstream of the downstream-side end portion 181 of the facing portion 185 in the rotation direction of the facing member 430.

Here, the roles of the first magnetic member 170 and the second magnetic member 180 will be described.

The second magnetic member 180 restricts movement of a developer moving in a direction represented by “15A” in the drawing.

In the present exemplary embodiment, a magnetic field is formed between the facing portion 185 of the second magnetic member 180 and the plurality of magnetic poles 120 provided inside the facing member 430.

Accordingly, a developer layer, which extends along the rotation direction of the facing member 430, is formed between the facing portion 185 and the facing member 430. Hereinafter, the developer layer will be referred to as a “rotation direction layer”.

Movement of a developer moving in the direction represented by “15A” in the drawing is restricted by the rotation direction layer.

Movement of a developer that moves to the one end portion 432 side from the central portion 430C of the facing member 430 along the axial direction of the facing member 430 is restricted by the rotation direction layer.

Note that the central portion 430C of the facing member 430 is shown in FIG. 7.

Accordingly, in the present exemplary embodiment, scattering of a developer that is caused by movement of the developer moving in the axial direction of the facing member 430 is suppressed.

Meanwhile, the first magnetic member 170 restricts movement of a developer moving to the downstream side in the rotation direction of the facing member 430. Accordingly, scattering of a developer that is caused by movement of the developer moving to the downstream side in the rotation direction of the facing member 430 is suppressed.

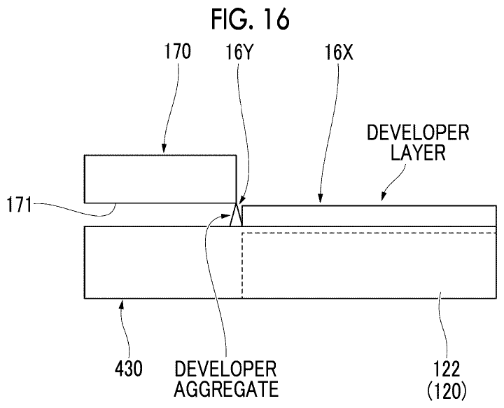

FIG. 16 is a cross-sectional view of the developing device 14 taken along the line XVI-XVI of FIG. 15.

In the present exemplary embodiment, as represented by a reference numeral “16Y” in the drawing, developers are collected at the position of generation of a magnetic field formed between the first magnetic member 170 and the second magnetic pole 122 due to the magnetic field. Hereinafter, the developers collected at a position represented by the reference numeral “16Y” will be referred to as a “developer aggregate”. Note that although not described above, in the present exemplary embodiment, the first magnetic member 170 and the magnetic poles 120 are provided in a state of being offset from each other in the axial direction of the facing member 430.

In the present exemplary embodiment, movement of a developer caused to move toward the downstream side in the rotation direction of the facing member 430 is restricted by the developer aggregate.

In the present exemplary embodiment, a developer adhering to the outer peripheral surface of the facing member 430 moves from the rear side to the front side of the paper surface of FIG. 16 as the facing member 430 rotates. The movement of the developer is restricted by the developer aggregate.

Furthermore, beside the developer aggregate, a band-shaped developer layer is formed by the second magnetic pole 122 as represented by a reference numeral “16X”. In the present exemplary embodiment, movement of a developer caused to move toward the downstream side in the rotation direction of the facing member 430 is restricted by the band-shaped developer layer as well.

Accordingly, scattering of a developer that is caused by movement of the developer moving to the downstream side in the rotation direction of the facing member 430 is suppressed.

In the present exemplary embodiment, as described above, movement of a developer moving in the axial direction of the facing member 430 is restricted by the second magnetic member 180 shown in FIG. 15.

Meanwhile, such movement is not completely restricted and as represented by a reference numeral “15X” in FIG. 15, the developer partially passes through a space between the second magnetic member 180 and the facing member 430.

Specifically, for example, passage of a developer as represented by the reference numeral “15X” in FIG. 15 is likely to occur at a position represented by a reference numeral “13E” or a reference numeral “13F” in FIG. 13.

No magnetic pole 120 is present near the position represented by the reference numeral “13E” or the reference numeral “13F” in FIG. 13. In this case, at the position represented by the reference numeral “13E” or the reference numeral “13F”, the size of a magnetic field formed between the second magnetic member 180 and the magnetic pole 120 is small. In this case, passage of a developer as represented by the reference numeral “15X” in FIG. 15 is likely to occur at the position represented by the reference numeral “13E” or the reference numeral “13F”.

A developer that has passed through the space between the second magnetic member 180 and the facing member 430 reaches a position represented by a reference numeral “16X” in FIG. 16 as the facing member 430 rotates.

A developer is present at the position represented by the reference numeral “16X”. In this case, movement of the developer that has reached the position represented by the reference numeral “16X” is restricted at the position represented by the reference numeral “16X”.

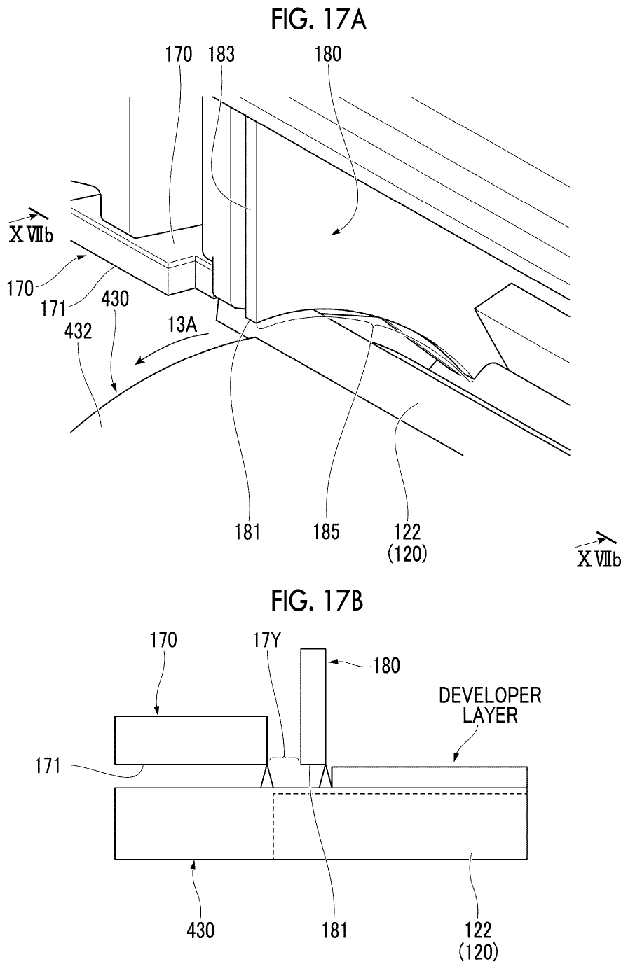

FIGS. 17A and 17B are views showing a comparative example regarding the second magnetic member 180 or the like.

In the comparative example, as shown in FIG. 17A, the downstream-side end portion 181 of the facing portion 185 is positioned downstream of the second magnetic pole 122 in the rotation direction of the facing member 430.

In this case, a cross section taken along line XVIIb-XVIIb in FIG. 17A is as shown in FIG. 17B.

In a state as shown in FIG. 17B, a developer positioned near a space between the facing portion 185 and the second magnetic pole 122 is pulled to the space due to a magnetic field formed between the facing portion 185 and the second magnetic pole 122.

In this case, a developer is removed from a position represented by a reference numeral “17Y”, so that a band-shaped developer layer is partially removed.

In this case, a developer moves to the downstream side in the rotation direction of the facing member 430 through the position of the partial removal. In this case, a developer caused to move from the back side to the front side of the paper surface of FIG. 17B passes through the band-shaped developer layer.

In other words, in this case, a developer that adheres to the outer peripheral surface of the facing member 430 and that moves to the downstream side in the rotation direction of the facing member 430 passes through the band-shaped developer layer.

In this case, scattering of the developer is likely to occur.

However, in the case of a configuration of the present exemplary embodiment shown in FIGS. 13 to 16, occurrence of partial removal of a developer is suppressed and scattering of the developer is suppressed.

In the present exemplary embodiment, as shown in FIG. 14, the downstream-side end portion 181 of the facing portion 185 is positioned downstream of the intermediate position M in the rotation direction of the facing member 430.

Accordingly, it is easy to suppress movement of a developer moving in the axial direction of the facing member 430 in comparison with a case where the downstream-side end portion 181 is positioned upstream of the intermediate position M.

In the present exemplary embodiment, as described above, movement of a developer moving in the axial direction is restricted by the second magnetic member 180.

In a case where the downstream-side end portion 181 of the facing portion 185 is positioned upstream of the intermediate position M, a region where the movement is restricted is small in comparison with a case where the downstream-side end portion 181 is positioned downstream of the intermediate position M.

However, in a case where the downstream-side end portion 181 of the facing portion 185 is positioned downstream of the intermediate position M, the region where the movement is restricted is large.

Although the exemplary embodiment of the present invention has been described above, the technical scope of the exemplary embodiment of the present invention is not limited to the above exemplary embodiment. In addition, various modifications and alternative configurations are involved in the present invention without departing from the technical scope of the present invention.

### Supplementary Notes

(((1)))

A developing device comprising:

a rotating member that is formed in a tubular shape, that is provided to be rotatable, that includes one end portion and the other end portion, and that includes an outer peripheral surface to which a developer adheres;

a plurality of magnetic poles that are disposed inside the rotating member and that are disposed to be arranged in a rotation direction of the rotating member;

a first magnetic member that is disposed outside the rotating member, that is disposed at a position facing the one end portion of the rotating member, that includes a downstream-side end portion, which is an end portion positioned on a downstream side in the rotation direction of the rotating member, and that forms a magnetic field between the first magnetic member and the magnetic poles; and

a second magnetic member that is disposed outside the rotating member, that is disposed at a position facing the one end portion of the rotating member, that is disposed to be closer to the other end portion of the rotating member than the first magnetic member is, that forms a magnetic field between the second magnetic member and the magnetic poles, and that includes a facing portion, which is a portion facing the rotating member,

wherein, in the rotation direction, the facing portion of the second magnetic member is positioned upstream of one of the plurality of magnetic poles that is positioned upstream of the downstream-side end portion of the first magnetic member in the rotation direction and that is a first magnetic pole counting from the downstream-side end portion.
(((2)))

The developing device according to (((1))),

wherein the facing portion of the second magnetic member includes a downstream-side end portion, which is an end portion positioned on the downstream side in the rotation direction of the rotating member, and

in the rotation direction, the downstream-side end portion of the facing portion of the second magnetic member is positioned downstream of a second magnetic pole counting from the downstream-side end portion of the first magnetic member to an upstream side in the rotation direction.
(((3)))

The developing device according to (((2))),

wherein, in the rotation direction, the downstream-side end portion of the facing portion of the second magnetic member is positioned downstream of an intermediate position positioned between the first magnetic pole and the second magnetic pole.
(((4)))

The developing device according to any one of (((1))) to (((3))),

wherein, in the rotation direction, the second magnetic member is provided upstream of a virtual plane that extends along a radial direction of the rotating member and that extends toward the first magnetic pole from a rotation center of the rotating member.
(((5)))

The developing device according to (((4))),

wherein the facing portion of the second magnetic member includes a downstream-side end portion, which is an end portion positioned on the downstream side in the rotation direction of the rotating member,

the second magnetic member includes a downstream-side edge that is positioned on the downstream side in the rotation direction of the rotating member, that is connected to the downstream-side end portion of the second magnetic member, and that extends in a direction away from the rotating member, and

the second magnetic member is provided such that the entire downstream-side edge of the second magnetic member is provided upstream of the virtual plane in the rotation direction and the virtual plane and the second magnetic member do not intersect each other.
(((6)))

An image forming apparatus comprising:

an image holding body that holds an image; and

a developing device that causes a developer to adhere to the image holding body,

wherein the developing device has a configuration of the developing device according to any one of (((1))) to (((5))).
(((7)))

A developing device that is composed of a plurality of constituent members and that causes a developer to adhere to an image holding body holding an image, the developing device comprising:

an opening that is disposed in a state of facing an image holding body side; and

a blocking member that partially blocks the opening and that is disposed in a state where a gap is provided between the blocking member and a constituent member that is disposed on a side opposite to a side on which the image holding body is installed with the blocking member interposed therebetween,

wherein supply of air to an inside of the gap between the blocking member and the constituent member from an outside of the gap is performed in a plurality of directions.
(((8)))

The developing device according to (((7))),

wherein a facing member that is provided to be rotatable and that is disposed at a position facing the image holding body is provided as the constituent member in the developing device,

the blocking member is disposed in a state where a gap is provided between the blocking member and the facing member,

the blocking member includes one axial end portion and the other axial end portion of which positions are different from each other in an axial direction of the facing member provided to be rotatable, and

air is supplied to the gap from both of one axial end portion side and the other axial end portion side of the blocking member.
(((9)))

The developing device according to (((8))),

wherein one end-portion-side opening, which is an opening that allows air to flow into the gap, is provided between the one axial end portion of the blocking member and the facing member,

the other end-portion-side opening, which is an opening that allows air to flow into the gap, is provided between the other axial end portion of the blocking member and the facing member, and

a size of the one end-portion-side opening and a size of the other end-portion-side opening are different from each other.
(((10)))

The developing device according to (((9))),

wherein the blocking member is disposed at a position facing an end portion of the facing member in the axial direction and is disposed in a state where the gap is provided between the blocking member and the end portion, and

an opening that is one of the one end-portion-side opening and the other end-portion-side opening and that is positioned on a side opposite to a central portion side in the axial direction of the facing member is smaller than an opening that is the other of the one end-portion-side opening and the other end-portion-side opening and that is positioned on the central portion side.
(((11)))

A developing device comprising:

a supply member that is disposed at a position facing an image holding body performing rotation, that is disposed along an axial direction of the image holding body, and that supplies a developer to the image holding body; and

a restriction member that is disposed at a position facing an end portion of the supply member in an axial direction, that is disposed in a state where a gap is provided between the restriction member and the end portion, and that restricts movement of the developer moving toward an image holding body side from a supply member side,

wherein the restriction member includes a central-portion-side end portion, which is an end portion positioned on a central portion side in the axial direction of the supply member, and an opposite-side end portion, which is an end portion positioned on a side opposite to the central-portion-side end portion, and

an opening that allows air outside the gap to flow into the gap is provided between the opposite-side end portion and the supply member.
(((12)))

The developing device according to (((11))),

wherein the opening is provided in a shape extending in a vertical direction, and

a width of a portion of the opening that is positioned on a lower side and a width of a portion of the opening that is positioned on an upper side are different from each other.
(((13)))

The developing device according to (((12))),

wherein the width of the portion positioned on the lower side is larger than the width of the portion positioned on the upper side.
(((14)))

The developing device according to any one of (((11))) to (((13))), further comprising:

an inlet portion that air to be sucked enters and of which a position in a rotation direction of the supply member performing rotation is different from a position where the opening is installed,

wherein a position of the opening in the axial direction of the supply member and a position of the inlet portion in the axial direction are different from each other.
(((15)))

The developing device according to (((14))),

wherein the inlet portion is provided in a state where the inlet portion is closer to the central portion side in the axial direction of the supply member than a central portion of the restriction member in the axial direction of the supply member is.
(((16)))

An image forming apparatus comprising:

an image holding body that holds an image formed thereon; and

a developing device that causes a developer to adhere to the image holding body,

wherein the developing device has a configuration of the developing device according to any one of (((7))) to (((15))).

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A developing device comprising:
a rotating member that is formed in a tubular shape, that is provided to be rotatable, that includes one end portion and the other end portion, and that includes an outer peripheral surface to which a developer adheres;
a plurality of magnetic poles that are disposed inside the rotating member and that are disposed to be arranged in a rotation direction of the rotating member;
a first magnetic member that is disposed outside the rotating member, that is disposed at a position facing the one end portion of the rotating member, that includes a downstream-side end portion, which is an end portion positioned on a downstream side in the rotation direction of the rotating member, and that forms a magnetic field between the first magnetic member and the magnetic poles; and
a second magnetic member that is disposed outside the rotating member, that is disposed at a position facing the one end portion of the rotating member, that is disposed to be closer to the other end portion of the rotating member than the first magnetic member is, that forms a magnetic field between the second magnetic member and the magnetic poles, and that includes a facing portion, which is a portion facing the rotating member,
wherein, in the rotation direction, the facing portion of the second magnetic member is positioned upstream of one of the plurality of magnetic poles that is positioned upstream of the downstream-side end portion of the first magnetic member in the rotation direction and that is a first magnetic pole counting from the downstream-side end portion.

2. The developing device according to claim 1,
wherein the facing portion of the second magnetic member includes a downstream-side end portion, which is an end portion positioned on the downstream side in the rotation direction of the rotating member, and
in the rotation direction, the downstream-side end portion of the facing portion of the second magnetic member is positioned downstream of a second magnetic pole counting from the downstream-side end portion of the first magnetic member to an upstream side in the rotation direction.

3. The developing device according to claim 2,
wherein, in the rotation direction, the downstream-side end portion of the facing portion of the second magnetic member is positioned downstream of an intermediate position positioned between the first magnetic pole and the second magnetic pole.

4. The developing device according to claim 1,
wherein, in the rotation direction, the second magnetic member is provided upstream of a virtual plane that extends along a radial direction of the rotating member and that extends toward the first magnetic pole from a rotation center of the rotating member.

5. The developing device according to claim 4,
wherein the facing portion of the second magnetic member includes a downstream-side end portion, which is an end portion positioned on the downstream side in the rotation direction of the rotating member,
the second magnetic member includes a downstream-side edge that is positioned on the downstream side in the rotation direction of the rotating member, that is connected to the downstream-side end portion of the second magnetic member, and that extends in a direction away from the rotating member, and
the second magnetic member is provided such that the entire downstream-side edge of the second magnetic member is provided upstream of the virtual plane in the rotation direction and the virtual plane and the second magnetic member do not intersect each other.

6. An image forming apparatus comprising:
an image holding body that holds an image; and
a developing device that causes a developer to adhere to the image holding body,
wherein the developing device has a configuration of the developing device according to claim 1.

7. An image forming apparatus comprising:
an image holding body that holds an image; and
a developing device that causes a developer to adhere to the image holding body,
wherein the developing device has a configuration of the developing device according to claim 2.

8. An image forming apparatus comprising:
an image holding body that holds an image; and
a developing device that causes a developer to adhere to the image holding body,
wherein the developing device has a configuration of the developing device according to claim 3.

9. An image forming apparatus comprising:
an image holding body that holds an image; and
a developing device that causes a developer to adhere to the image holding body,
wherein the developing device has a configuration of the developing device according to claim 4.

10. An image forming apparatus comprising:
an image holding body that holds an image; and
a developing device that causes a developer to adhere to the image holding body,
wherein the developing device has a configuration of the developing device according to claim 5.

11. A developing device that is composed of a plurality of constituent members and that causes a developer to adhere to an image holding body holding an image, the developing device comprising:
an opening that is disposed in a state of facing an image holding body side; and
a blocking member that partially blocks the opening and that is disposed in a state where a gap is provided between the blocking member and a constituent member that is disposed on a side opposite to a side on which the image holding body is installed with the blocking member interposed therebetween,
wherein supply of air to an inside of the gap between the blocking member and the constituent member from an outside of the gap is performed in a plurality of directions.

12. The developing device according to claim 11,
wherein a facing member that is provided to be rotatable and that is disposed at a position facing the image holding body is provided as the constituent member in the developing device,
the blocking member is disposed in a state where a gap is provided between the blocking member and the facing member,
the blocking member includes one axial end portion and the other axial end portion of which positions are different from each other in an axial direction of the facing member provided to be rotatable, and
air is supplied to the gap from both of one axial end portion side and the other axial end portion side of the blocking member.

13. The developing device according to claim 12,
wherein one end-portion-side opening, which is an opening that allows air to flow into the gap, is provided between the one axial end portion of the blocking member and the facing member,
the other end-portion-side opening, which is an opening that allows air to flow into the gap, is provided between the other axial end portion of the blocking member and the facing member, and
a size of the one end-portion-side opening and a size of the other end-portion-side opening are different from each other.

14. The developing device according to claim 13,
wherein the blocking member is disposed at a position facing an end portion of the facing member in the axial direction and is disposed in a state where the gap is provided between the blocking member and the end portion, and
an opening that is one of the one end-portion-side opening and the other end-portion-side opening and that is positioned on a side opposite to a central portion side in the axial direction of the facing member is smaller than an opening that is the other of the one end-portion-side opening and the other end-portion-side opening and that is positioned on the central portion side.

15. A developing device comprising:
a supply member that is disposed at a position facing an image holding body performing rotation, that is disposed along an axial direction of the image holding body, and that supplies a developer to the image holding body; and
a restriction member that is disposed at a position facing an end portion of the supply member in an axial direction, that is disposed in a state where a gap is provided between the restriction member and the end portion, and that restricts movement of the developer moving toward an image holding body side from a supply member side,
wherein the restriction member includes a central-portion-side end portion, which is an end portion positioned on a central portion side in the axial direction of the supply member, and an opposite-side end portion, which is an end portion positioned on a side opposite to the central-portion-side end portion, and
an opening that allows air outside the gap to flow into the gap is provided between the opposite-side end portion and the supply member.

16. The developing device according to claim 15,
wherein the opening is provided in a shape extending in a vertical direction, and
a width of a portion of the opening that is positioned on a lower side and a width of a portion of the opening that is positioned on an upper side are different from each other.

17. The developing device according to claim 16,
wherein the width of the portion positioned on the lower side is larger than the width of the portion positioned on the upper side.

18. The developing device according to claim 15, further comprising:
an inlet portion that air to be sucked enters and of which a position in a rotation direction of the supply member performing rotation is different from a position where the opening is installed,
wherein a position of the opening in the axial direction of the supply member and a position of the inlet portion in the axial direction are different from each other.

19. The developing device according to claim 18,
wherein the inlet portion is provided in a state where the inlet portion is closer to the central portion side in the axial direction of the supply member than a central portion of the restriction member in the axial direction of the supply member is.
